(19) United States
(12) Patent Application Publication
(10) Pub. No.: US 2026/0290723 A1
(43) Pub. Date: Sep. 24, 2026

(54) KEYBOARD

(71) Applicant: Shanghai Flydigi Electronics Technology Co.,Ltd., Shanghai (CN)

(72) Inventors: Wen FAN, Shanghai (CN); Yawu ZHANG, Shanghai (CN); Wei HUANG, Shanghai (CN)

(73) Assignee: Shanghai Flydigi Electronics Technology Co.,Ltd., Shanghai (CN)

(21) Appl. No.: 19/684,064

(22) Filed: May 21, 2026

Related U.S. Application Data
(63) Continuation of application No. PCT/CN2025/095734, filed on May 19, 2025.

(30) Foreign Application Priority Data
Jul. 31, 2024 (CN) 202411039238.5
Jul. 31, 2024 (CN) 202421842128.8

(51) Int. Cl. H01H 13/86

(52) U.S. Cl. CPC H01H 13/86

(57) ABSTRACT

A keyboard includes an outer housing, a fixing layer, a plurality of key structures and a cutoff member. The fixing layer is connected to the outer housing. The plurality of key structures are mounted on the fixing layer, each of the plurality of key structures includes a shaft body and a reset member. The shaft body is slidable relative to the fixing layer, and the reset member is configured to reset the shaft body. The cutoff member is connected to the outer housing and configured to limit the downward movement of the shaft body.

### CROSS-REFERENCE TO RELATED APPLICATIONS

The present application is a continuation application of International Application No. PCT/CN2025/095734, filed on May 19, 2025, which claims priority to Chinese Patent Application No.202421842128.8, filed on Jul. 31, 2024, and Chinese Patent Application No. 202411039238.5, filed on Jul. 31, 2024. The disclosures of the above-mentioned applications are incorporated herein by reference in their entireties.

### TECHNICAL FIELD

The present application relates to the technical field of external devices, and in particular to a keyboard.

### BACKGROUND

A keyboard is an instruction and data input device for operating equipment, and is now widely used in people's work, entertainment and other scenarios. At present, a fixing layer is provided in some keyboards on the market, a circuit board is provided between the fixing layer and a bottom housing of the keyboard, and key structures are mounted on the fixing layer. When the key structures move downward, the circuit board can generate induction signals through optical induction, magnetic induction, contact induction or the like, so as to realize data input.

However, in the existing keyboards, the key structures limit the downward movement of the key shafts through the fixing layer. The key shafts collide with the fixing layer during the downward movement, and the fixing layer vibrates, which affects other key structures mounted on the fixing layer. After long-term use, the stability of the fixing layer is prone to decline, resulting in the problem of multi-key false triggering, and lowering the service life of the keyboard.

### SUMMARY

The main purpose of the present application is to provide a keyboard, aiming to reduce the vibration of the fixing layer when the keyboard is tapped.

To achieve the above purpose, the present application provides a keyboard, including:
an outer housing;
a fixing layer connected to the outer housing;
a plurality of key structures mounted on the fixing layer, where each of the plurality of key structures includes a shaft body slidable relative to the fixing layer and a reset member configured for resetting the shaft body; and
a cutoff member connected to the outer housing and configured to limit a downward movement of the shaft body.

In some embodiments of the present application, the cutoff member is a cutoff plate, and an edge of the cutoff plate is connected to the outer housing.

In some embodiments of the present application, the cutoff plate includes a plate body and a plurality of elastic limiting portions connected to the plate body, an edge of the plate body is connected to the outer housing, and one of the plurality of elastic limiting portions is aligned opposite to the shaft body.

In some embodiments of the present application, the plate body is provided with a plurality of limit holes, and the plurality of elastic limiting portions are elastic cantilevers connected to walls of the plurality of limit holes.

In some embodiments of the present application, each of the elastic cantilevers includ two curved arms and a limiting section, one end of each of the two curved arms is connected to two opposite sides of the limiting section, and the other end of each of the two curved arms is connected to the walls of the plurality of limit holes.

In some embodiments of the present application, the plate body includes a main body and a support arm connected to an edge of the main body, a partition opening is formed between the main body and the support arm, and the support arm is connected to the outer housing.

In some embodiments of the present application, the outer housing includes a top housing covering outside the fixing layer and a bottom housing connected to a lower side of the top housing, the fixing layer is provided with a plurality of mounting openings, the top housing is provided with a clearance hole to expose the plurality of mounting openings, and the cutoff plate is located between the fixing layer and the bottom housing.

In some embodiments of the present application, the keyboard further includes a first gasket padded between the edge of the cutoff plate and the fixing layer and/or a second gasket padded between the edge of the cutoff plate and the bottom housing.

In some embodiments of the present application, the keyboard further includes a circuit board mounted in the outer housing and located between the fixing layer and the cutoff member;
where the keyboard further includes a first sound-absorbing layer sandwiched between the cutoff plate and the circuit board, and the first sound-absorbing layer is provided with a plurality of avoidance holes aligned opposite to a plurality of shaft bodies; and/or
the keyboard further includes a second sound-absorbing layer sandwiched between the cutoff plate and the bottom housing.

In some embodiments of the present application, the circuit board is provided with a plurality of key position through holes and a plurality of sensing portions, one of the plurality of sensing portions is adjacent to one of the plurality of key position through holes, the key structure further includes a mounting base, the shaft body includes a key shaft and a trigger member mounted on the key shaft, the mounting base is aligned opposite to the plurality of key position through holes, a sliding hole is formed in the mounting base, the key shaft is slidably mounted in the sliding hole, and the trigger member is configured to trigger a corresponding sensing portion; and
the reset member is a return spring, and two ends of the return spring are respectively connected to the mounting base and the key shaft.

With the above solution, when the key structure is pressed, the shaft body moves down until it abuts against the cutoff member, and the key shaft collides with the cutoff member to generate vibration. The vibration source is spaced from the fixing layer, and the fixing layer is less affected by vibration. The fixing layer can remain stable when the keyboard is tapped at high frequency, the service life of the fixing layer is effectively prolonged, and the risk of false triggering of the key structures mounted on the fixing layer due to vibration is avoided.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a keyboard according to an embodiment of the present application.

FIG. 2 is an exploded view of the keyboard according to an embodiment of the present application.

FIG. 3 is an enlarged view at portion A in FIG. 2.

FIG. 4 is an exploded view of a key structure according to an embodiment of the present application.

FIG. 5 is a sectional view of the key structure according to an embodiment of the present application.

FIG. 6 is an enlarged view at portion B in FIG. 5.

The realization of the objective, functional characteristics, and advantages of the present application are further described with reference to the accompanying drawings.

### DETAILED DESCRIPTION OF THE EMBODIMENTS

The technical solutions in the embodiments of the present application will be clearly and completely described below with reference to the drawings in the embodiments of the present application. Obviously, the described embodiments are only a part of the embodiments of the present application, rather than all of the embodiments. Based on the embodiments in the present application, all other embodiments obtained by those skilled in the art without creative efforts shall fall within the scope of the present application.

It should be noted that if directional indications (such as up, down, left, right, front, back . . . ) are involved in the embodiments of the present application, the directional indications are only used to explain the relative positional relationship, movement conditions, etc. between components in a specific posture. If the specific posture changes, the directional indications will change accordingly.

In addition, if the descriptions of “first”, “second” are involved in the embodiments of the present application, the descriptions of “first”, “second” are only configured for descriptive purposes and cannot be understood as indicating or implying their relative importance or implicitly indicating the number of indicated technical features. Thus, the features defined with “first” and “second” may explicitly or implicitly include at least one of the features. In addition, “and/or” as used throughout the text includes three parallel solutions, for example, “A and/or B” includes solution A, solution B, or solutions A and B implemented together. In addition, the technical solutions of the various embodiments may be combined with each other, but must be based on the realization by those skilled in the art. When the combination of technical solutions is contradictory or cannot be realized, it should be considered that the combination of technical solutions does not exist and is not within the scope required by the present application.

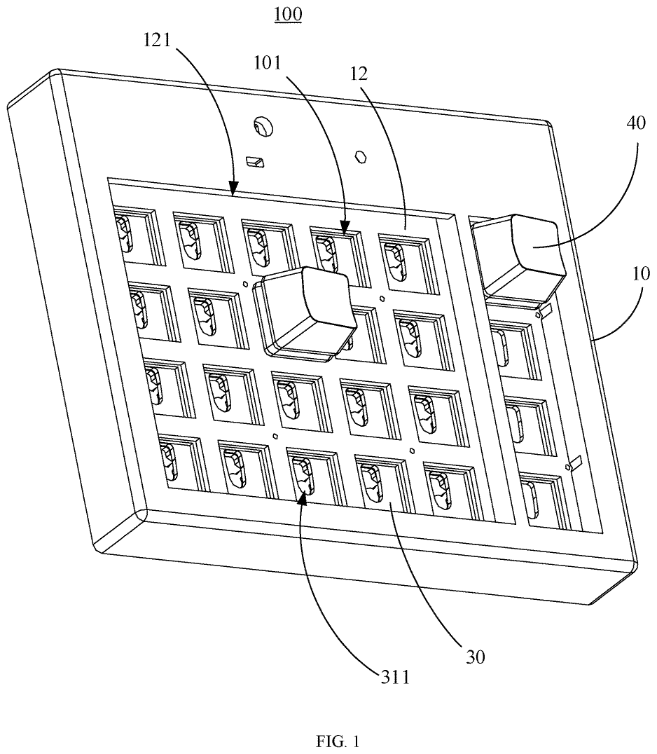

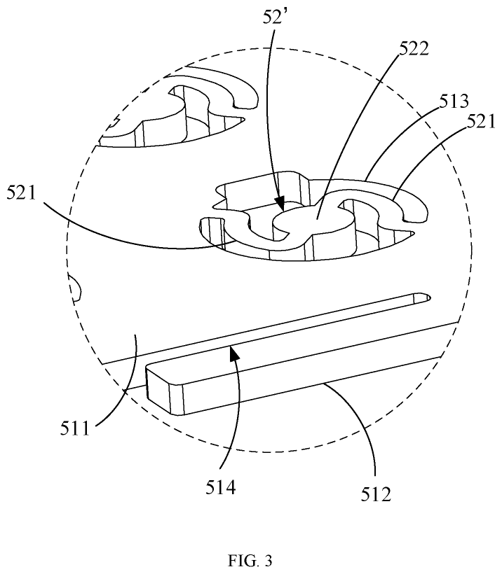

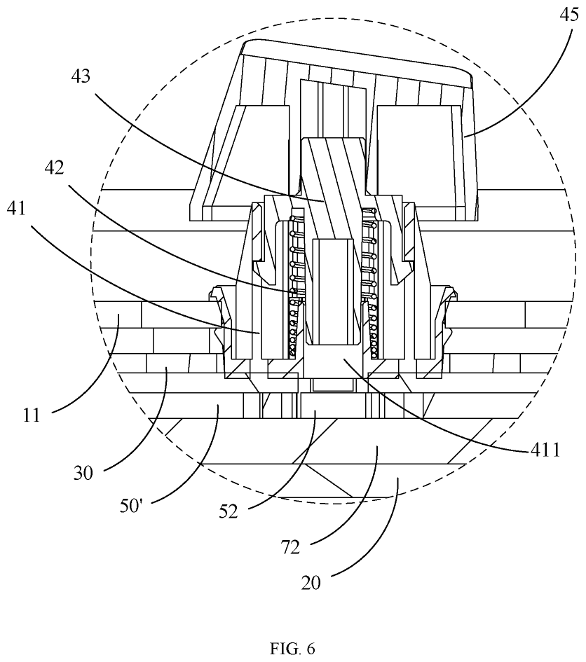

Please refer to FIGS. 1 to 6, the present application provides a keyboard 100, includi an outer housing 10, a fixing layer 11, a plurality of key structures 40 and a cutoff member 50. The fixing layer 11 is connected to the outer housing 10. The key structures 40 are mounted on the fixing layer 11, each of the key structures 40 includes a shaft body and a reset member 42, the shaft body is slidable relative to the fixing layer 11, and the reset member 42 is configured for resetting the shaft body. The cutoff member 50 is connected to the outer housing 10, and the cutoff member 50 is configured for limiting the downward movement of the shaft body.

With the above solution, when the key structure 40 is pressed, the shaft body moves down until it abuts against the cutoff member 50. The key shaft 43 collides with the cutoff member 50 to generate vibration, and the vibration source is spaced from the fixing layer 11. The fixing layer 11 is less affected by vibration, the fixing layer 11 can remain stable when the keyboard 100 is tapped at high frequency. The service life of the fixing layer 11 is effectively prolonged, and the risk of false triggering of the key structures 40 mounted on the fixing layer 11 due to vibration is avoided.

The outer housing 10 is generally made of plastic materials, such as PC plastic, ABS plastic, PVC plastic, etc. The fixing layer 11 may be connected to the outer housing 10 by snap fit or integrally formed, which is implemented according to specific conditions and is not limited herein.

The key structure 40 generally further includes a key cap 45 and a mounting base 41, and the key cap 45 is mounted on the top of the key shaft 43. The mounting base 41 is generally provided with a sliding hole 411 and an upward limiting structure, the key shaft 43 is slidably mounted in the sliding hole, and the upward limiting structure is snap-fitted with the key shaft 43 to prevent the key shaft 43 from coming out of the sliding hole 411.

The cutoff member 50 has various structures. In some embodiments of the present application, the cutoff member 50 is a limiting column connected to the housing. A plurality of limiting columns are provided, and each of the limiting columns is respectively aligned opposite to the key shaft 43 to limit the downward movement of the key shaft 43.

In some embodiments of the present application, the cutoff member 50 is a cutoff plate 50′, and an edge of the cutoff plate 50′ is detachably connected to the outer housing 10. Thus, when the cutoff plate 50′ is damaged, only the cutoff plate 50′ can be removed for replacement, the repair cost is low, and the assembly is convenient.

The cutoff plate 50′ may be provided above the fixing layer 11 or below the fixing layer 11. In some embodiments of the present application, the cutoff plate 50′ is provided above the fixing layer 11, the cutoff plate 50′ is provided with an avoidance hole 711, and a limiting protrusion is protruded from a side wall of the key shaft 43. When the key shaft 43 moves down in the avoidance hole 711, the limiting protrusion abuts against an upper surface of the cutoff plate 50 thereby limiting the movement of the key shaft 43.

To further improve the damping effect, in some embodiments of the present application the cutoff plate 50′ includes a plate body 51 and a plurality of elastic limiting portions 52, and an edge of the plate body 51 is fixed to the outer housing 10. The plurality of elastic limiting portions 52 are connected to the plate body 51, and one elastic limiting portion 52 is aligned opposite to one shaft body. In this way, the key shaft 43 is in flexible impact when contacting the elastic limiting portion 52, and the damping effect is better. In addition, since the vibration source is located below the fixing layer 11, the tapping sound generated by the vibration source is greatly weakened during propagation to the keyboard 100, which has a noise reduction effect.

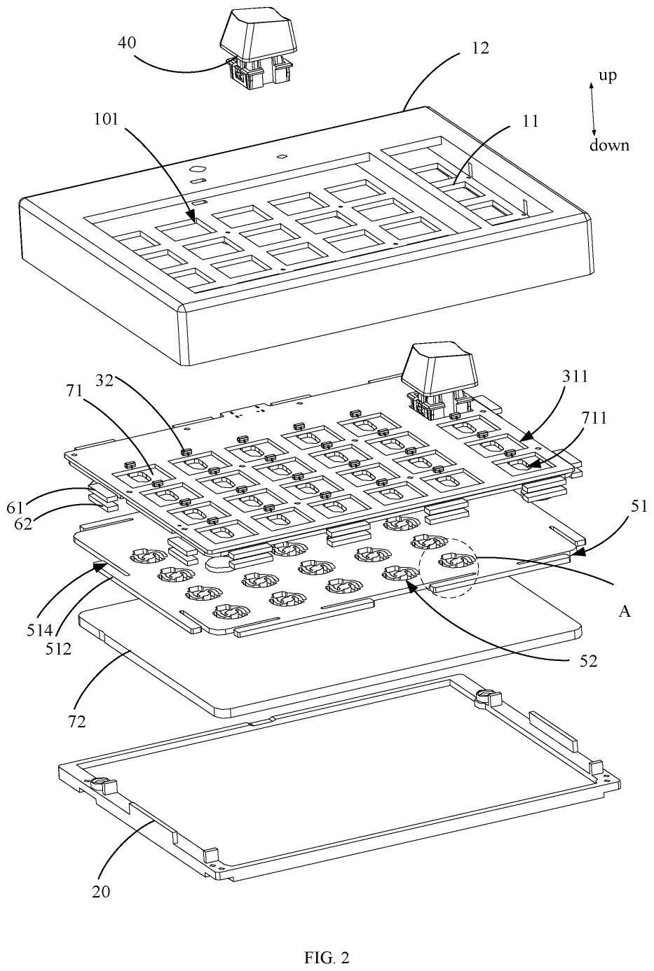

The elastic limiting portion 52 has various specific implementations. In some embodiments of the present application, the elastic limiting portion 52 is a silicone pad connected to the top surface of the plate body 51. Please refer to FIG. 2, in other embodiments of the present application, the plate body 51 is provided with a plurality of limit holes 513, and the elastic limiting portion 52 is an elastic cantilever 52′ connected to a wall of the limit hole 513. Thus, the elastic limiting portion 52 and the plate body 51 may be an integrated structure, which can be directly obtained by hot pressing, injection molding, 3D printing, thereby reducing the number of parts and lowering the structural complexity. Moreover, the elastic limiting portion 52 does not increase the overall thickness of the cutoff member 50, which is conducive to improving the structural compactness.

Further, in some embodiments of the present application, the elastic cantilever 52′ includes two curved arms 521 and a limiting section 522. One end of each of the two curved arms 521 is respectively connected to two opposite sides of the limiting section 522, and the other end is connected to the wall of the limit hole 513. In this way, the damping effect of the elastic cantilever 52′ is better.

In some embodiments of the present application, the plate body 51 includes a main body 511 and a support arm 512. The support arm 512 is connected to an edge of the main body 511, a partition opening 514 is formed between the support arm 512 and the support arm 512, and the support arm 512 is connected to the outer housing 10. Thus, when the vibration propagates from the center of the plate body 51 to the edge, the vibration wave passing through the partition opening 514 is cut off, only a small part of the vibration propagates to the support arm 512, and the damping effect is better.

In some embodiments of the present application, the outer housing 10 includes a top housing 12 and a bottom housing 20, and the bottom housing 20 is connected to a lower side of the top housing 12. The fixing layer 11 is provided with a plurality of mounting openings 101, and the top housing 12 covers the fixing layer. The top housing is provided with a clearance hole 121 to expose the mounting opening 101, and the cutoff plate 50′ is located between the fixing layer 11 and the bottom housing 20. Thus, the outer housing 10 has good structural stability and convenient assembly.

In some embodiments of the present application, the keyboard 100 further includes a first gasket 61 padded between an edge of the cutoff plate 50′ and the top housing 12. In other embodiments of the present application, the keyboard 100 further includes a second gasket 62 padded between an edge of the cutoff plate 50′ and the bottom housing 20. The damping effect is further improved.

In some embodiments of the present application, the keyboard 100 further includes a circuit board 30 mounted in the outer housing 10, and the circuit board 30 is located between the fixing layer 11 and the cutoff plate 50′. The keyboard 100 further includes a first sound-absorbing layer 71 sandwiched between the cutoff plate 50′ and the circuit board 30, and the first sound-absorbing layer 71 is provided with a plurality of avoidance holes 711 aligned opposite to the plurality of key shafts 43. In other embodiments of the present application, the keyboard 100 further includes a second sound-absorbing layer 72 sandwiched between the cutoff plate 50′ and the bottom housing 20. Thus, the two sound-absorbing layers can absorb sound, and the noise reduction effect is better.

The circuit board 30 may be connected and fixed to the top housing 12 or the bottom housing 20. In some embodiments of the present application, the circuit board 30 is connected to a surface of the fixing layer 11 facing the bottom housing 20. Thus, on the one hand, the circuit board 30 is close to the top housing 12, which facilitates the sensing portion 32 to be triggered by the trigger member 44; on the other hand, the circuit board 30 can block sound, and the noise reduction effect is better.

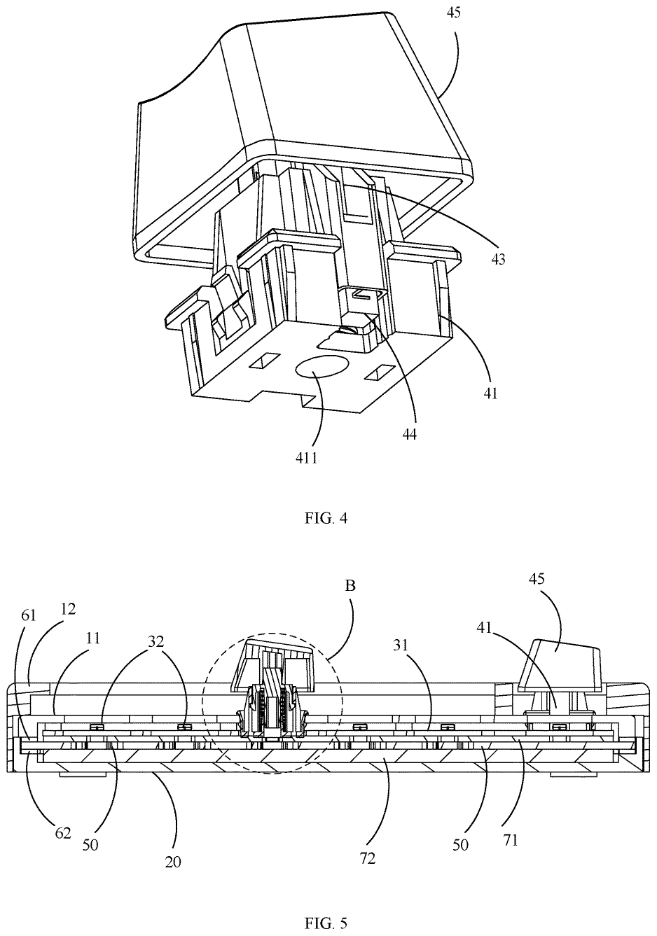

With reference to FIG. 4, in some embodiments of the present application, the circuit board is provided with a plurality of key position through holes 311 and sensing portions 32, and one sensing portion 32 is provided adjacent to one key position through hole 311. The key structure 40 further includes a mounting base 41, and the shaft body includes a key shaft 43 and a trigger member 44 mounted on the key shaft 43. The mounting base is aligned opposite to the key position through hole 311, and a sliding hole 411 is formed in the mounting base 41. The key shaft 43 is slidably mounted in the sliding hole 411, and the trigger member 44 is configured for triggering the corresponding sensing portion 32. The reset member 42 is a return spring, and two ends of the return spring are respectively connected to the mounting base 41 and the key shaft 43.

The types of the trigger member 44 and the sensing portion 32 are various. For example, the trigger member 44 is a magnetic member, and the sensing portion 32 is a Hall element. When the magnetic member moves under the drive of the key shaft 43, the Hall element senses the change of the surrounding magnetic field to generate an induction signal. For another example, the trigger member 44 is a light reflecting member, and the sensing portion 32 is a photoelectric sensor. After th key is pressed, the detection light emitted by the emitting end of the photoelectric sensor irradiates the light reflecting member and is reflected, and then received by the receiving end, so as to generate an induction signal. There are many specific implementations of the trigger member 44 and the sensing portion 32, which will not be listed one by one herein.

The above are only embodiments of the present application, and are not intended to limit the scope of the present application. Any equivalent structural transformation made by using the contents of the description and drawings of the present application under the technical concept of the present application, or direct/indirect application in other related technical fields, shall be included in the scope of the present application.

What is claimed is:

1. A keyboard, comprising:
an outer housing;
a fixing layer connected to the outer housing;
a plurality of key structures mounted on the fixing layer, wherein each of the plurality of key structures comprises a shaft body slidable relative to the fixing layer and a reset member configured for resetting the shaft body; and
a cutoff member connected to the outer housing and configured to limit a downward movement of the shaft body.

2. The keyboard according to claim 1, wherein the cutoff member is a cutoff plate, and an edge of the cutoff plate is connected to the outer housing.

3. The keyboard according to claim 2, wherein the cutoff plate comprises a plate body and a plurality of elastic limiting portions connected to the plate body, an edge of the plate body is connected to the outer housing, and one of the plurality of elastic limiting portions is aligned opposite to the shaft body.

4. The keyboard according to claim 3, wherein the plate body is provided with a plurality of limit holes, and the plurality of elastic limiting portions are elastic cantilevers connected to walls of the plurality of limit holes.

5. The keyboard according to claim 4, wherein each of the elastic cantilevers comprises two curved arms and a limiting section, one end of each of the two curved arms is connected to two opposite sides of the limiting section, and the other end of each of the two curved arms is connected to the walls of the plurality of limit holes.

6. The keyboard according to claim 3, wherein the plate body comprises a main body and a support arm connected to an edge of the main body, a partition opening is formed between the main body and the support arm, and the support arm is connected to the outer housing.

7. The keyboard according to claim 2, wherein the outer housing comprises a top housing covering outside the fixing layer and a bottom housing connected to a lower side of the top housing, the fixing layer is provided with a plurality of mounting openings, the top housing is provided with a clearance hole to expose the plurality of mounting openings, and the cutoff plate is located between the fixing layer and the bottom housing.

8. The keyboard according to claim 7, further comprising:
a first gasket padded between the edge of the cutoff plate and the fixing layer; and
a second gasket padded between the edge of the cutoff plate and the bottom housing.

9. The keyboard according to claim 7, further comprising:
a circuit board mounted in the outer housing and located between the fixing layer and the cutoff member;
wherein the keyboard further comprises a first sound-absorbing layer sandwiched between the cutoff plate and the circuit board, and the first sound-absorbing layer is provided with a plurality of avoidance holes aligned opposite to a plurality of shaft bodies; and
the keyboard further comprises a second sound-absorbing layer sandwiched between the cutoff plate and the bottom housing.

10. The keyboard according to claim 9, wherein the circuit board is provided with a plurality of key position through holes and a plurality of sensing portions, one of the plurality of sensing portions is adjacent to one of the plurality of key position through holes, the key structure further comprises a mounting base, the shaft body comprises a key shaft and a trigger member mounted on the key shaft, the mounting base is aligned opposite to the plurality of key position through holes, a sliding hole is formed in the mounting base, the key shaft is slidably mounted in the sliding hole, and the trigger member is configured to trigger a corresponding sensing portion; and
the reset member is a return spring, and two ends of the return spring are respectively connected to the mounting base and the key shaft.

11. The keyboard according to claim 1, wherein the shaft body comprises a key shaft and a magnetic member mounted on the key shaft;
the keyboard further comprises:
a circuit board mounted in the outer housing and provided with a plurality of Hall elements, wherein one of the plurality of Hall elements corresponds to the magnetic member of the key structure, and the magnetic member is configured to trigger a corresponding Hall element.

12. The keyboard according to claim 11, wherein the circuit board is located between the fixing layer and the cutoff member and further provided with a plurality of key position through holes for the shaft body to pass through, and one of the plurality of Hall elements is adjacent to one of the plurality of key position through holes.

13. The keyboard according to claim 12, wherein the key structure further comprises a mounting base, the circuit board is provided between the fixing layer and the cutoff member, the mounting base is aligned opposite to the plurality of key position through holes, a sliding hole is formed in the mounting base, and the key shaft is slidably mounted in the sliding hole.

14. The keyboard according to claim 13, wherein the reset member is a return spring, and two ends of the return spring are respectively connected to the mounting base and the key shaft.

15. The keyboard according to claim 12, wherein the cutoff member is a cutoff plate, and an edge of the cutoff plate is connected to the outer housing.

16. The keyboard according to claim 15, further comprising:
a first sound-absorbing layer sandwiched between the cutoff plate and the circuit board, wherein the first sound-absorbing layer is provided with a plurality of avoidance holes aligned opposite to a plurality of shaft bodies.

17. The keyboard according to claim 15, wherein the outer housing comprises a top housing and a bottom housing connected to a lower side of the top housing, and the keyboard further comprises a second sound-absorbing layer sandwiched between the cutoff plate and the bottom housing.

18. The keyboard according to claim 15, further comprising:
a first gasket padded between an edge of the cutoff plate and the fixing layer.

19. The keyboard according to claim 15, wherein the outer housing comprises a top housing covering outside the fixing layer and a bottom housing connected to a lower side of the top housing, the fixing layer is provided with a plurality of mounting openings, the top housing is provided with a clearance hole to expose the plurality of mounting openings, and the cutoff plate is located between the fixing layer and the bottom housing.

20. The keyboard according to claim 19, further comprising:
a second gasket padded between an edge of the cutoff plate and the bottom housing.
